(19) United States
(12) Patent Application Publication
(10) Pub. No.: US 2010/0101500 A1
(43) Pub. Date: Apr. 29, 2010

(54) Universal Cell for Medical Imaging of a Small Animal Under Anesthesia

(75) Inventors: Vincent Sannie, Corfelix (FR); Sebastien Sannie, Marolles en Brie (FR)

Correspondence Address: SUTHERLAND ASBILL & BRENNAN LLP, 999 PEACHTREE STREET, N.E., ATLANTA, GA, 30309, US

(73) Assignee: EQUIPEMENT VETERINAIRE MINERVE, Esternay (FR)

(21) Appl. No.: 12/301,809

(22) PCT Filed: May 24, 2006
(86) PCT No.: PCT/FR06/01218

§ 371 Date: Jan. 15, 2009

(51) Int. Cl. A61D 7/04

(52) U.S. Cl. 119/420

(57) ABSTRACT

The invention relates to equipment for a small laboratory animal designed to keep it under volatile anesthesia then to insert it into an imaging system for medical imaging investigations. It makes sure the vigilant animal has pre-anesthesia by means of a direct induction device of anesthetizing gas, its anesthesia prolonged by means of the usable device for keeping it in the open or closed position. This device makes direct access possible by the blood or respiratory pathway. The temperature of the animal is controlled and modulated by means of a nonmagnetic heat exchanger. The invention takes into account the safety of the users in regard to their exposure to halogens thanks to the double sealing connection system and thanks to the induction device that does not impregnate the coat of the animal that they have to handle.

The invention lies in the field of research activities associated with techniques involving medical imaging investigation of small laboratory animals such as magnetic resonance imaging, X-ray micro-tomodensitometry, techniques making use of scintigraphy by single-photon and two-photon emitters, and optical imaging. Image acquisition can be spread over several hours, and the possibly contaminated animals need to be kept calm, insensitive to pain, and unmoving. This physiological state is characterized by good chemical or volatile general anesthesia, good ventilation, and good maintenance of the body temperature of the animal.

The invention, made of non-magnetic materials, is constituted by two devices, one of which performs pre-anesthesia and the other of which maintains the laboratory animal under prolonged volatile anesthesia and isolates it from ambient air while enabling it to be subjected to medical treatment via the blood or respiration. Furthermore, the latter device that contains the animal under treatment is designed to be transferred, manually or by a robotic system, and then inserted in an imager in order to acquire medical images.

### STATE OF THE PRIOR ART

In order to ensure pre-anesthesia of an animal, there exist induction cages or chambers that have in common:
they require the available volume to be filled with anesthetic gas and then the same volume to be emptied prior to extracting the animal for continued processing;
they are heavy consumers of anesthetic agents, vector gas, and other consumables for collecting the extracted polluting vapors;
they are awkward to handle, requiring the animal to be prevented from moving for a relatively long time and they involve considerable overall treatment time (for given induction parameters, depending on the model of cage and on the manufacturer, and depending on the physiological characteristics of the animal, from 2 to 4 minutes); and
they require systems to be put into place for capturing excess halogenated gas in order to protect users form exposure to halogen.

Nevertheless they do not avoid impregnating the animal's coat with halogenated vapors, and particles thereof evaporate directly into the working environment of users.

In order to enable the animal to be maintained under prolonged volatile anesthesia, existing systems are designed on the principle of double-pipe circuits with induction of anesthetic gas and simultaneous extraction of polluting gas or excess pressure. In their present form, certain systems perform the function of putting the animal to sleep and of maintaining it under volatile anesthesia, as required in many research applications. Depending on the model and the manufacturer, they may be simple or they may enable the animal to be heated in order to avoid hypothermia and the consequences thereof.

Nevertheless, existing systems are neither non-magnetic, nor designed to be transferred manually or automatically, nor insertable in an imager such that the need for investigations by medical imaging is not satisfied.

### SUMMARY OF THE INVENTION

The invention relates to the hardware aspect downstream from a source for dispensing anesthetic gas and a system for dynamically extracting halogenated gas under positive pressure.

The invention relates to a method and a device designed to process both the function of putting a laboratory animal to sleep and the function of prolonged volatile anesthesia associated with accurate and reproducible positioning of the animal's body, heating it, isolating it from ambient air, and treating it medically via the blood or respiration; such that medical imaging investigations can be undertaken on the animal under study.

The device is constituted by:
a direct gas induction system that provides fast pre-anesthesia of the animal while avoiding impregnating its coat with halogenated vapors. This device can nevertheless be dissociated from the field of medical imaging since it can be used purely and simply to replace the induction chamber or cage in any of the fields of application where use is made thereof; and
a transferable isolation cell used to relay the direct induction system is made of non-magnetic materials of densities that are compatible with medical imaging appliances. It may be provided in a plurality of sizes and be suitable for insertion in the space determined by each type of imager; which space may have a diameter lying in the range 30 millimeters (mm) to 120/150 mm.

The cell makes the following possible:
prolonged anesthesia of the animal under study to be maintained for several hours;
provision of maximum available space for the animal while satisfying the requirements for the cells for insertion in an imager to be of small size;
isolation of the possibly contaminated animal from ambient air and users;
provision of safe access means going from the outside to the inside of the isolation cell enabling various accessories to be put into place for monitoring physiological parameters of the anesthetized animal and for sequentially delivering various gas mixtures that are specific to medical imaging (hyperpolarized gas);
coping with a drop in the body temperature of the animal, whether spontaneous or inherent to anesthesia;
accurate and reproducible positioning of the body of the animal under study;
manual or robotic transfer of the isolation cell occupied by the animal to appliances dedicated to performing medical imaging investigations, such as:
   magnetic resonance imaging (MRI);
   X-ray micro-tomodensitometry (X-ray micro-scanner, micro-CT);
   techniques making use of scintigraphy by single-photon emitters (micro-gamma camera, micro-single photon emission computerized tomography (SPECT)) and two-photon emitters (micro-positron emission tomography (micro-PET)); and
   optical imaging of the small animal (fluorescent emitters); and
ensuring user safety, by means of safe double-closure connectors fitted to all of the stations and the accessories.

Concerning the induction device: it is an accessory for the anesthetic gas generator that enables the animal under investigation to be put to sleep. It is connected by means of a coaxial circuit that enables two flows of gas to be passed simultaneously. One flow goes from the generator to the device, while the other goes the other way from the device to a unit for sucking in residual pollutant gas. The circuit is provided at each end with a male connector having a double-closure system. Such connectors are designed to connect with a female connector, itself provided with a double-closure system. If the male/female connectors with double closure are separated from each other, then the delivery of the halogenated gas stream and the extraction of the residual polluted gas are shut off. This equipment serves not only to isolate the coaxial circuit itself from the environment, but also all of the devices that are connected thereto. Furthermore, there is no emission of halogenated gas into the environment if the coaxial circuit—connected to the anesthetic gas generator—is not connected to the induction device or to the isolation cell.

The double-closure male/female connectors are designed, on coupling, to activate extraction of residual gas initially and subsequently induction of anesthetic, so that any halogenated gas leak at the time of coupling will be collected. They provide safety when connecting peripheral equipment to the anesthesia station. This system of safe male/female connectors fitted to the anesthetic gas generator, to the induction device, and to the isolation cell forms an integral portion of the invention.

The induction device is constituted by a main body fastened to a structure providing the assembly with mechanical stability, and by two securable moving portions constituted by the induction cylinder and by the moving body. At its rear end, the induction cylinder is provided with a conical portion of dimensions adapted to the animal species it is to contain and to induce. The front end is mounted in a pivot connection relative to the structure. The angular stroke of the pivot connection is restricted to 90° so that the induction cylinder can go from a vertical position to a horizontal position.

In the horizontal position, the induction cylinder enables the live animal to be put into place, head first. Transition from the horizontal position to the vertical position is performed manually by the user of the device. This operation mechanically opens a valve situated in the body of the structure. It allows halogenated gas to pass via a channel that opens out into the front portion of the cylinder and that terminates specifically at the animal's muzzle. The induction effects are practically immediate because of the lack of any dead volume needing to be saturated. The delivery rate of anesthetic gas can remain very low, i.e. at about a volume equal to the product of the current volume multiplied by the breathing frequency of the species of animal concerned (V=VC×freq). The induction cylinder is fitted with permanent suction situated upstream from the anesthetic gas delivery source. This suction is in operation whatever the position of the cylinder (vertical or horizontal) so as to collect excess halogenated gas from as close as possible to the emission source. The central portion of the cylinder has a transparent window and enables the user to view the behavior of the animal under induction.

At the end of the required induction time, i.e. an exposure of about 20 seconds (s) to 30 s, the user interrupts the delivery of anesthetic gas by tilting the cylinder from the vertical position to the horizontal position. The sleeping animal, whose coat has been protected from halogenated vapor, can be extracted from the induction cylinder. To do this, the operator separates the cylinder from its structure and thus has access to the front portion of the animal. The animal can easily be removed and positioned on a standard accessory for maintaining anesthesia or in the isolation cell while in the open position. During this period of handling, suction remains active and removes residual halogen particles.

This device provides a significant saving in time (being of the order of five to six times quicker than an induction cage), increased user safety (the coats of the animals being handled are preserved from halogenated vapor). The costs of experiments are therefore reduced in terms of the amounts of anesthetic agent, vector gas, and filter elements that are consumed.

Concerning the transferable isolation cell: it is likewise an accessory of the anesthetic gas generator. It enables an animal that is to be inserted in an imager to be maintained under gaseous anesthesia. It is connected to the generator by means of a coaxial circuit enabling two flows of gas to pass simultaneously. One flow goes from the anesthetic gas generator to the device, while the other flow goes the other way from the device towards a suction unit for residual polluted gas. The circuit is the same type as that used with the induction device.

The isolation cell is constituted by a main body and by a moving portion with an isolating bubble. The assembly rests on a stationary structure that provides mechanical stability to the apparatus. When separated from its stationary structure, the isolation cell containing the animal can be transferred manually or by means of a robotic system to a unit for acquiring medical imaging data.

The main body is provided with two independent channels, one serving to pass cold gas extracted from the isolation cell and the other to pass said gas in return, which gas is reintroduced after being treated by the heater system. These two independent channels are connected at one end to pipes of a bed made of an extruded section member and at the other end to a heat exchanger integrated in the main body. The heater system operates in a closed loop and is made up of a gas extractor pump that is connected to a unit for regulating temperature and to the heat exchanger of the body, thereby serving to heat the extracted cold gas so that it is reintroduced into the cell at a temperature that is sufficient to enable the animal contained on the bed to conserve or recover the desired body temperature. In this main body there is engaged a holder tunnel with a service channel, with or without a perforatable membrane, enabling catheters, probes, electrodes, breathing circuits, pneumatic control circuits, etc. to be passed through. The moving portion is constituted by a support bed and by an outer transparent container. The bed is made of extruded section member having longitudinal channels for passing various fluids that need to be conveyed (induction/extraction of anesthetic gas, heat-conveying fluid, . . . ). The bed engages in the holder tunnel (itself engaged in the main body). The moving portion as a whole enables the animal to be restrained and to be isolated from ambient air when the outer container is screwed onto a knob for adjusting gas suction, which knob is placed on the main body. The parts making up this moving portion may be constituted by sterile units for single use in applications that must avoid any risk of cross-contamination. The cell can be used in the open position (animal not isolated) or in the closed position (with the animal isolated) if its outer transparent container is screwed to the knob for adjusting the suction power applied to the gas under pressure contained in the cell.

The open position is obtained by turning the control knob towards the induction/extraction position. It enables the user to position and/or restrain and/or prepare the animal that has just been extracted from the induction device and to place the animal on a bed of shapes and dimensions that match the morphology of the animal. The bed is adjustable to turn about the longitudinal axis, with longitudinal graduations and lug bars for stereotaxic restraints enabling the animal to be positioned accurately and reproducibly in the imager. The animal's muzzle is directed towards the cone with a tooth piece of the holder tunnel preventing it from moving and directing admitting halogen. At the periphery of the cone and downstream from the muzzle there are located extraction channels enabling suction of excess polluted gas to be maximized. After the animal has been put under anesthesia, after it has been connected to the equipment specific to the experimental protocol via the secure access going from the outside to the inside of the cell, and after it has been connected to the heater system, the user can transfer the heated animal directly to the imager while in the cell in the open position or can put the isolating bubble into place if the animal is to be isolated from ambient air.

The closed position is obtained by screwing the transparent bubble onto the control knob for adjusting the suction power applied to the gas under pressure, and then turning the control knob fully towards its induction+extra pressure position. The knob is actuated after the transparent bubble has been closed. Implementing this function has the consequence of allowing halogenated gas to pass towards the animal with extraction being deflected mechanically so that the inside of the cell is sucked out in part only. Mechanical deflection of extraction thus avoids suction being established inside the cell. The animal, maintained under anesthesia, heated, isolated from the ambient surroundings, and treated depending on the requirements of the application, is ready to be transferred manually or by a robot system from the preparation zone to the zone for investigation by medical imaging, or to be put on standby for later treatment. In the final stage of the experiment, the animal is removed from the cell which might be reused after being decontaminated and/or re-fitted with other optionally sterile elements.

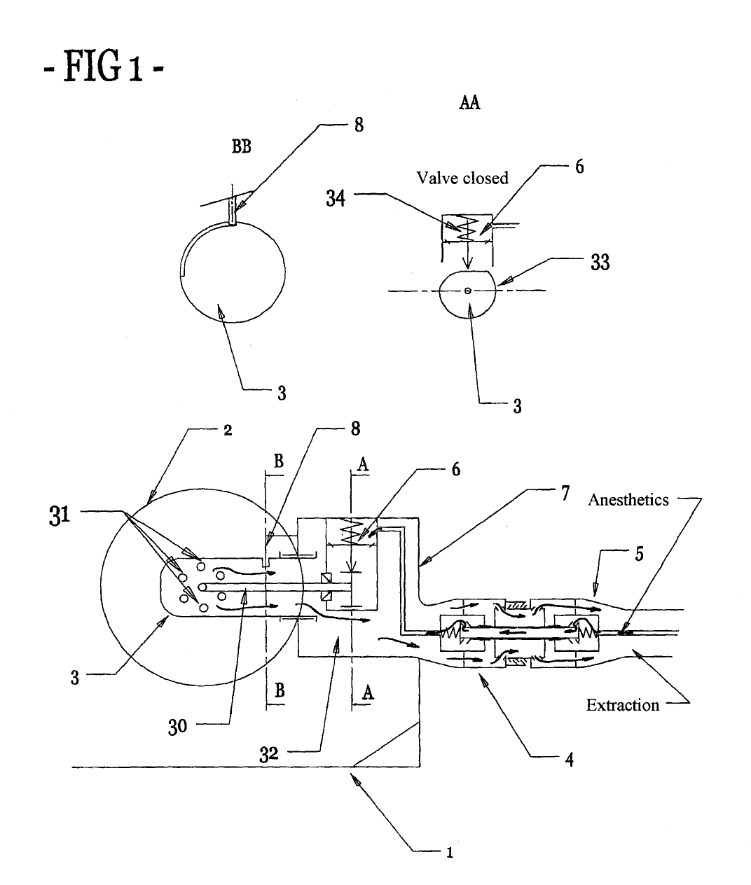

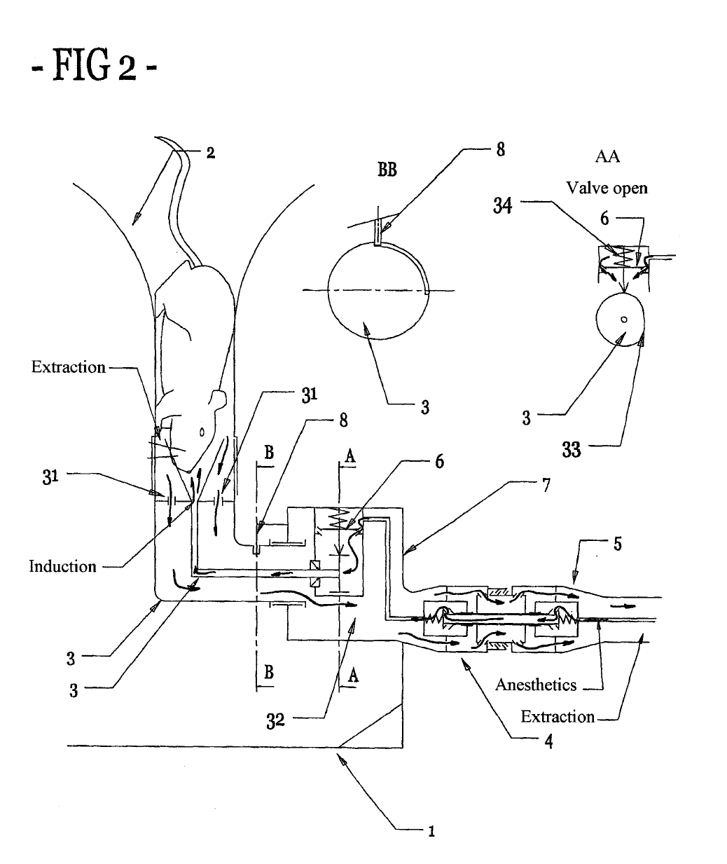

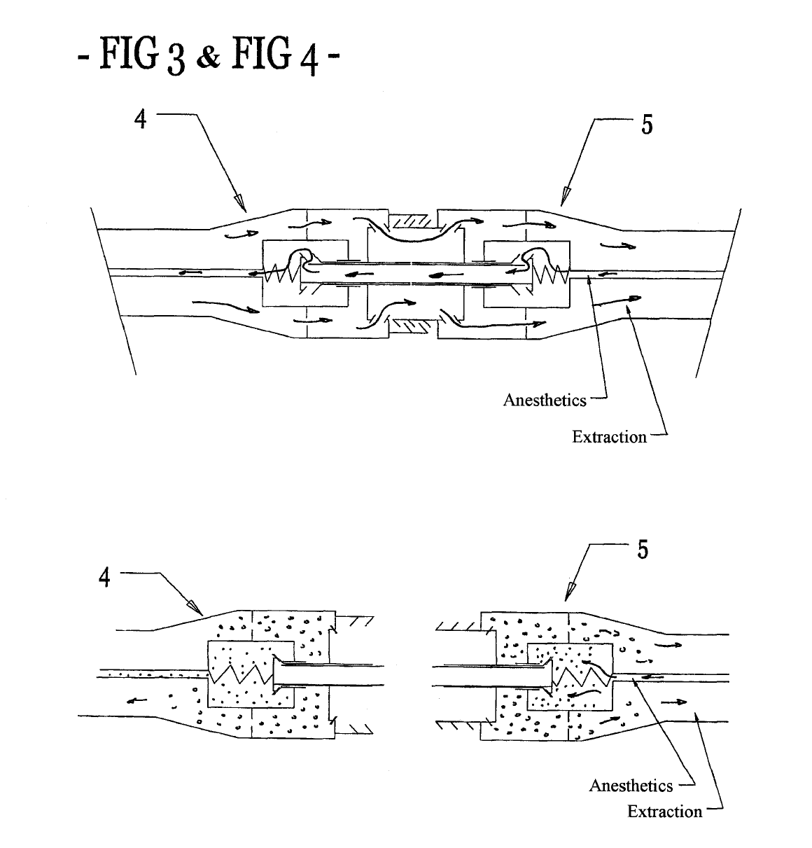

### BRIEF SUMMARY OF THE EIGHT DIAGRAMS OF APPENDICES 1 TO 6 constituting the induction device (FIGS. 1 and 2), the secure system of double-closure male/female connectors (FIGS. 3 and 4), and the transferable isolation cell (FIGS. 5, 6, 7, and 8):

1/8 schematic diagram of the HORIZONTAL CYLINDER induction device (FIG. 1):
section AA valve-closed view; and
section BB view showing the end of cylinder turning;

2/8 schematic diagram of the VERTICAL CYLINDER induction device (FIG. 2):
section AA valve-open view; and
section BB view showing the end of cylinder turning;

3/8 schematic diagram of the male/female connectors when CONNECTED (FIG. 3);

4/8 schematic diagram of the male/female connectors when DISCONNECTED (FIG. 4);

5/8 schematic diagram of the non-isolated cell in the OPEN POSITION (FIG. 5):
section AA view showing the end of turning the knob; and
section BB view showing the closed air intake;

6/8 schematic diagram of the isolated cell in the CLOSED POSITION (FIG. 6):
section AA view showing the end of turning the knob; and
section BB view of the open air intake;

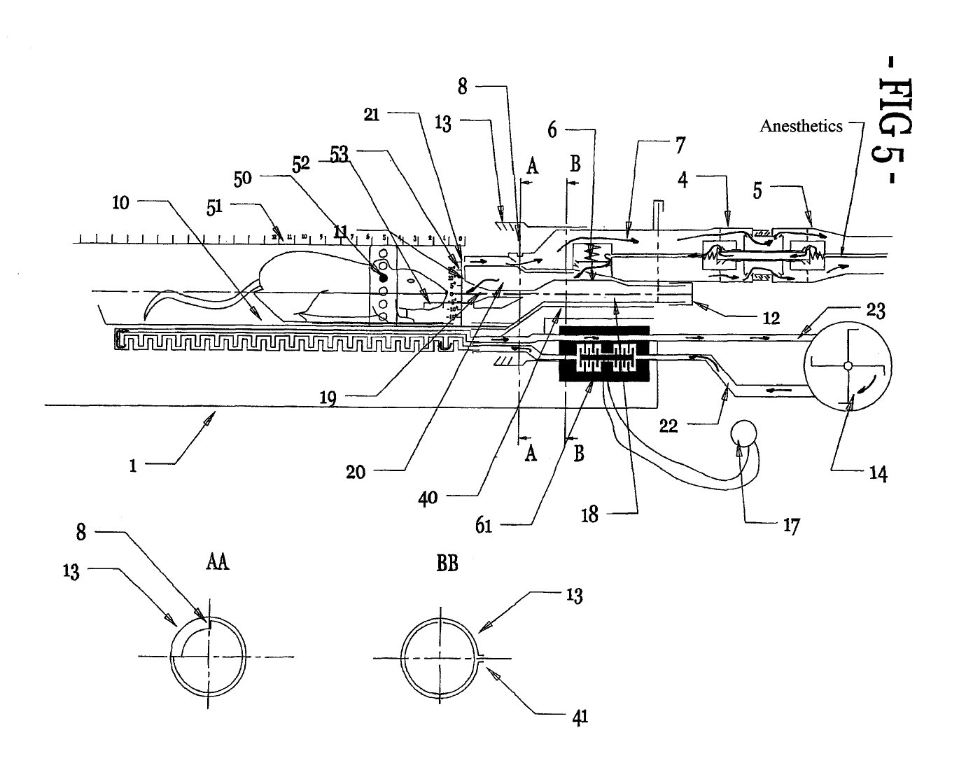

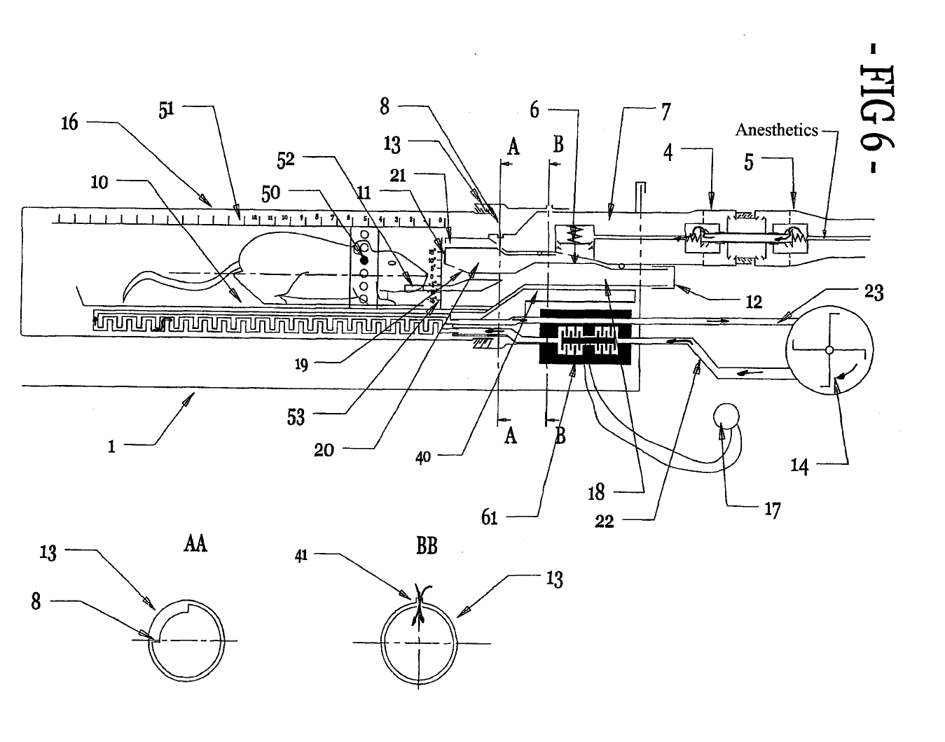

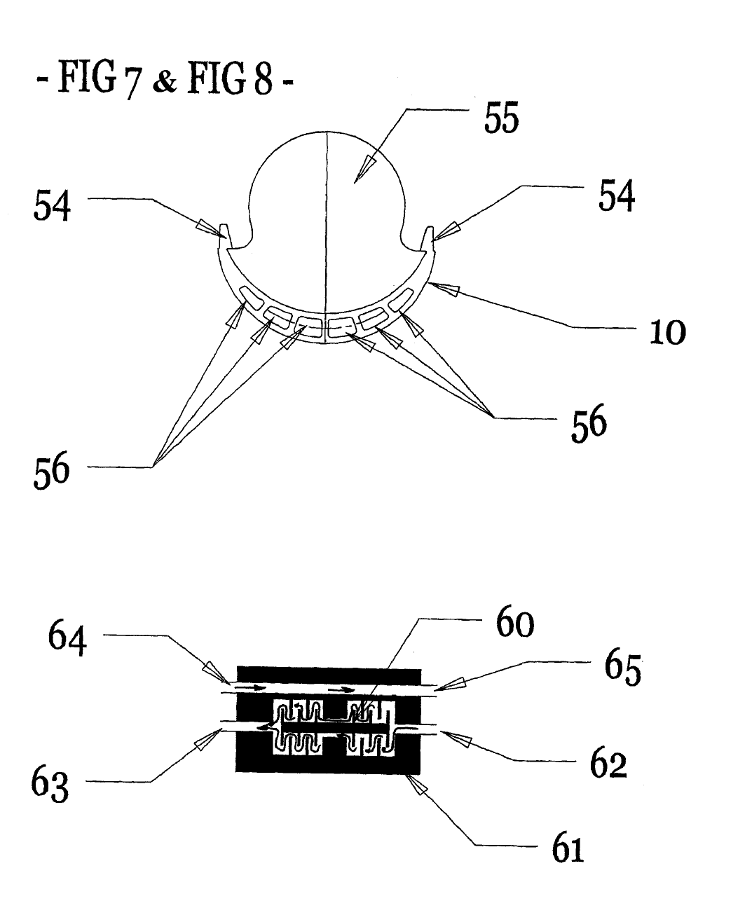

7/8 diagrammatic section view of a model of bed with longitudinal channels enabling a plurality of fluids to be passed and enabling accessories to be fastened by means of clips (FIG. 7); and

8/8 diagrammatic section view of the heat exchanger inserted in the main body (FIG. 8).

### DETAILED DESCRIPTION OF AN EMBODIMENT with reference to the diagrams of FIGS. 1 to 8

FIGS. 1 and 2: the induction device is permanently connected to a stationary structure (1) placed on a mattress or on a work surface. This structure that provides stability to the mechanical assembly is of dimensions, shape, and weight that ensure it remains stable during the induction stage. The induction device comprises a main body (7) fastened to the structure, having a double-closure female coaxial connector (4) integrated therein and two moving portions that can be secured to each other. The first portion is constituted by the induction and restraint cylinder (2), and the second is constituted by the moving body (3). The female coaxial connector (4) fitted to the main body (7) needs to be connected (FIG. 3) and screwed to the double-closure male coaxial connector (5) of the coaxial circuit connecting the anesthetic gas generator to the induction device in order to enable two free and independent flows of gas to take place. The first flow conveys halogenated gas from the anesthetic gas generator to the induction device. The second flow extracts residual halogenated gas from the induction device and returns it to the polluted gas suction unit situated downstream.

If the female coaxial connector (4) is disconnected (FIG. 4) from the male connector (5), then both gas flows are closed off so that there is no emission of halogenated gas to nor any suction of ambient air from the working environment. In addition, the systems situated upstream and downstream from the male/female connectors are completely isolated.

The moving portion, referred to as the induction and restrained cylinder (2), is of shape and size that match the morphology of the animal that is to be subjected to induction. The induction cylinder, provided with a monitoring window, has a central opening allowing halogenated gas to pass freely to the muzzle of the animal for induction and has peripheral channels (31) enabling residual halogens to be extracted freely. The induction cylinder (2) can be separated quickly from the moving body (3) during operations of changing cylinders of greater or smaller size by disengagement.

The moving body (3) is mounted via a pivot connection on the main body (7) with pivoting being restricted to 90° so that the induction cylinder (2) can move from the horizontal position (FIG. 1) to the vertical position (FIG. 2). It is prevented from moving in rotation and translation relative to the main body (7) by a stop peg (8).

The moving body (3) is provided with a hole (32) enabling the suction channels (31) of the induction cylinder (2) to communicate with the dedicated hole of the main body (7) regardless of the position of the induction cylinder (2) (horizontal position in FIG. 1 or vertical position in FIG. 2), such that the extraction of residual halogenated gas is always active.

The end of the moving body (3) is provided with a cam (33) enabling halogenated gas to be turned on or off. Depending on whether the valve (6) is actuated (FIG. 2—section AA) or not actuated (FIG. 1—section AA), it is either spaced apart from or not spaced apart from the main body (7). It therefore has the function of opening or closing the halogenated gas inlet. When the induction cylinder (2) is in the horizontal position (FIG. 1), the halogenated gas is stopped at the valve (6) that is kept closed and in contact with the main body (7) by means of the spring (34). This position enables the animal to be put into place while awake. When the induction cylinder (2) is in the vertical position (FIG. 2), the halogenated gas can go through the open valve (6) that is spaced apart from the main body (7), and can pass through the moving body (3) and the central channel, going to the center of the induction cylinder. This position enables the animal that is awake to be put to sleep. The operating state of the equipment is identified on the moving body (3):
vertical position of the induction cone=extraction+induction (animal being subjected to induction); and
horizontal position of the induction cone=extraction (off or waiting for the animal to be induced).

FIGS. 5, 6, 7, and 8: the isolation cell is supported by an independent structure (1), itself placed on a mattress or a work surface. This structure (1) provides stability to the mechanical assembly and is of dimensions, shape, and weight such that it remains stable throughout the stage of preparing the previously-induced animal. The isolation cell comprises a main body (7) with a double-closure female coaxial connector (4), an adjustment knob (13), and three removable portions. The first portion comprises the bed (10) onto which the induced animal is placed; the second portion comprises the holder tunnel (11) with the cone (19) and the tooth piece (52); and the third portion comprises the outer transparent container (FIGS. 6-16). When assembled, the assembly can be separated from the structure (1) so as to be transferred to an imager.

The female coaxial connector (4) fitted to the main body (7) needs to be connected (FIG. 3) and screwed to the double-closure male coaxial connector (5) of the coaxial circuit that connects the anesthetic gas generator to the cell in order to establish two free and independent gas flows. The first flow conveys halogenated gas from the anesthetic gas generator to the isolation cell, and the second flow extracts residual polluted gas from the isolation cell and goes to the polluted gas suction unit situated downstream. If this female coaxial connector (4) is disconnected (FIG. 4) from the male connector (5), then both gas flows are shut off so there is no emission of halogenated gas to nor any suction of ambient air from the work environment. In addition, the systems situated upstream and downstream from the male/female connectors (4-5) are completely isolated.

The main body (7) is provided with two channels and with a hole (40) that is reserved for passing the holder tunnel (11) and for engaging it. These two channels have outlets for connecting to one end of the heater system operating in a closed loop and comprising a cold gas extractor pump (14), a temperature regulator unit (17), and a heat exchanger (61—FIGS. 5 and 6 and FIG. 8) integrated in the main body (7), and for connecting at the other end to the longitudinal channels (56—FIG. 7) of the bed (10). Thus, the cold gas (64-65, FIG. 8/8) extracted by the pump (14—FIGS. 5 and 6) from the longitudinal channels of the bed (56—FIG. 7) passes through the heater element (60) via the channels (62-63, FIG. 8) of the heat exchanger, picks up heat, and is returned heated to the longitudinal channels (56—FIGS. 7, and 5-6) of the bed (10). The channel (41) of the main body (7) enables the suction coming form the cone (19) to communicate with the outside.

The first removable portion, referred to as the bed (10), is of shape and size that match the morphology of the animals to be treated. The bed (10), fitted with a lug bar (50) and with graduations (51), is secured to the holder tunnel (11) itself fitted with a tooth piece (52) and can be separated merely by applying traction. It is made from an extruded section member (FIG. 7) enabling longitudinal channels (56) to be incorporated in its thickness, which channels are used for passing various fluids that need to be conveyed (induction/extraction of anesthetic gas, heat-conveying fluid for regulating the temperature of the animal contained on the bed). This section member, in the form of an arc of a circle, has a thickness of a few millimeters and a diameter that is appropriate, and it is provided with strips (54) onto which it is possible to clip various pairs of removable supports (55) for accessories. In an application that must avoid any risk of cross-contamination, the bed may be sterilized or for single use only.

The second removable portion, referred to as the holder tunnel (11), is provided with a cone (19) fitted with a tooth piece (52) on which the incisors of the animal for treatment are placed. In line with the holder tunnel (11) there is a service channel (18) that is optionally closed by a plug (12). The plug (12) can be perforated and provide safe access from the outside to the inside of the cell. The passage released in this way enables a catheter, probe, electrode, . . . to be placed that comes directly up to the animal's muzzle. These various pieces of equipment are put into place while the animal is being prepared. The holder tunnel (11) is also provided with a channel (20) dedicated to passing halogenated gas delivered directly to the animal's muzzle, and with peripheral channels (21) enabling residual halogenated gas to be sucked out. When the holder tunnel (11) is fully engaged in the main body (7), it actuates the valve (6) and allows halogenated gas to pass. When the holder tunnel (11) is removed from the main body (7), the valve (6) closes the passages for passing halogenated gas. The holder tunnel (11) can be tilted about its longitudinal axis. The holder tunnel (11) is provided with graduations (53) for determining the angle of inclination between the main body (7) and the tunnel (11). This feature enables the assembly comprising the bed (10)+the animal+the tunnel (11) to be oriented. The holder tunnel (11) can be separated quickly merely by pulling, and it is for single use like the bed (10) in the event of cross-contamination being a risk.

The third removable portion, referred to as the outer container (16), is transparent, of small thickness, and of shape and size that match the morphology of the animal, and it is screwed to the adjustment knob (13) by means of a thread for quick coupling. When it is put into place it isolates the animal for treatment completely from ambient air. The adjustment knob (13) is mounted with a pivot connection (FIG. 6, section AA) on the main body (7) with pivoting limited to 90° relative to the longitudinal axis of the cell. It is prevented from moving in rotation and in translation relative to the main body (7) by means of a stop peg (8). The knob (13) is adjusted to occupy two distinct positions:

1) open cell position (FIG. 5) for induction+extraction=extraction maximized since the suction channel is completely free while the animal is anesthetized, heated, but not isolated; and

2) cell closed position (FIG. 6) for induction+extra pressure=extraction minimized since the air inlet (41) situated outside the cell accentuates the effects of the reduction in suction. When the cell is closed, the extraction is used as a device for collecting residual halogenated gas while the animal is anesthetized, heated, and isolated from ambient air.

We claim:

1-23. (canceled)

24. A device for heated anesthesia and stereotaxic type restraint of a living small laboratory animal, the device being suitable for satisfying applications associated with medical imaging investigation techniques such as magnetic resonance imaging, X-ray micro-tomodensitometry, techniques making use of scintigraphy by single-photon and two-photon emitters, and optical imaging,
said device comprising:
equipment for inducing anesthetic gas to the muzzle of the animal, thus preserving the coat of the animal from the narcotic gas and enabling it to be subjected to pre-anesthesia; and
equipment for keeping the animal under prolonged anesthesia by induction of heated anesthetic gas, said equipment comprises a transferable cell for providing very accurate and reproducible positioning of the body and the head of the animal, heating of the surface of its body, and medical treatment thereof via the blood or respiration, as a result, the animal maintained under physiological conditions can be transferred manually or by means of a robotic system to an imager for acquiring medical images.

25. The device according to claim 24, further comprising a transparent outer container.

26. The device according to claim 24, further comprising an anesthetic gas generator and a system for extracting polluted gas, the device for direct induction of anesthetic gas and the transferable isolation cell are connected thereto by means of a coaxial circuit enabling two free and independent gas flows to be provided, one flow being dedicated to anesthetic gas induction, and the other flow being dedicated to extracting polluted gas.

27. The device according to claim 24, wherein the device for direct induction of anesthetic gas and the isolation cell have respective double-closure female connectors for connection to a double-closure male connector of a coaxial circuit such that two gases can flow in opposite directions, freely and independently, and flow in opposite directions is prevented if the male and female connectors are disconnected, such that the induction device or the isolation cell is isolated from the anesthetic gas generator and from the polluted gas extraction system.

28. The device according to claim 24, wherein the device for direct induction of anesthetic gas comprises two moving portions and a stationary portion secured to the structure, and one of the moving portions, referred to as the induction cylinder, can be separated from the second moving portion by disengagement.

29. The device according to claim 28, wherein the first moving portion is provided with a central channel allowing halogenated gas to flow freely and is provided with peripheral channels allowing residual halogenated gas to be extracted freely.

30. The device according to claim 28, wherein the moving body of the device for direct induction of anesthetic gas is mounted via a pivot connection on the main body, such that the induction cylinder can move from a horizontal position to a vertical position.

31. The device according to claim 28, wherein the moving body is provided with a free passage reserved for extraction, enabling the extraction of the main body to communicate with the suction channels of the induction cylinder, such that extraction of the residual halogenated gas is always active regardless of the position of the induction cylinder.

32. The device according to claim 28, wherein the moving body is provided with a controlled passage reserved for induction of anesthetic gas, enabling the anesthetic induction of the main body to communicate with the central channel of the induction cylinder in such a manner that anesthetic gas induction is activated when the induction cylinder passes from the horizontal position to the vertical position.

33. The device according to claim 28, wherein the end of the moving body is provided with a cam enabling the halogenated gas passage to be opened or closed depending on whether the induction cylinder is in the vertical position, or in the horizontal position.

34. The device according to claim 28, wherein the moving body is provided with a valve that, when held in contact with the main body with the help of a spring, deactivates the halogenated gas passage from the main body to the induction cylinder while the induction cylinder is in the horizontal position.

35. The device according to claim 28, wherein the moving body is provided with a valve that, when spaced apart from the main body by the cam, activates the passage of halogenated gas from the main body to the induction cylinder while it is in the vertical position.

36. The device according to claim 28, wherein the stationary portion of the device for direct induction of anesthetic gas, referred to as the main body, has two holes connected to the double-closure female connector, itself connected to the double-closure male connector of the coaxial circuit situated upstream from the device, and the first hole, reserved for extraction, is connected to the holes of the two moving portions, the second hole, reserved for controlled induction of anesthetic gas is connected to the holes of the two moving portions.

37. The device according to claim 24, wherein the transferable isolation cell has a bed, a holder tunnel and a transparent container as three removable portions fitted to the main body, itself fitted with an adjustment knob, and the assembly is supported by a support structure from which it can be removed in order to be transferred to a unit for requiring medical imaging data.

38. The device according to claim 37, wherein the isolation cell comprises, in addition to its three removable portions, a main body having two holes communicating at one end with the channels of the extruded section member of the bed when the bed is engaged in the holder tunnel, itself engaged in the main body, and at the other end with the system for heating the extracted cold air and constituted by a cold gas extractor pump, a temperature regulator unit and a heat exchanger.

39. The device according to claim 38, wherein the first hole connected to the inlet of the heat exchanger is reserved for extracting cold air coming from the channels of the bed with the help of the pump, and that the second hole, connected to the outlet of the heat exchanger is reserved to restoring the heated air to the channels of the bed.

40. The device according to claim 38, wherein the heat exchanger constituted by non-magnetic materials and inserted in the main body, constitutes a space for flow of the admitted cold air coming from the go circuit of the channels of the bed, which air then flows through a heater space such that the air is delivered at the outlet at the desired temperature and is finally directed to the return circuit of the channels of the bed.

41. The device according to claim 37, wherein the bed of the transferable isolation cell, is engageable with the holder tunnel, and has graduations and lug bars enabling the body of the animal to be positioned accurately and reproducibly and also enabling the body surface of the animal to be heated via the return channels for air that has been heated after passing through the space of the heat exchanger.

42. The device according to claim 41, wherein the bed is made from an extruded section member in the shape of a circular arc, of small thickness and of diameter matching the size of the animal, and has longitudinal channels and strips at its outer edges so that pairs of supports for medical accessories can be clipped thereto.

43. The device according to claim 37, wherein the holder tunnel when fully engaged in the main body is arranged to actuate the valve that allows anesthetic gas to pass.

44. The device according to claim 43, wherein the holder tunnel has a channel provided with a cone enabling anesthetic gas to pass that is heated by heat being transmitted from the heat exchanger, and provided with a tooth piece enabling the head of the animal to be subjected to stereotaxic type restraint, and the second channel is provided with a perforatable stopper giving access to the animal in position in the device.

45. The device according to claim 43, wherein the holder tunnel is provided with peripheral extraction channels enabling residual anesthetic gas to be sucked out and is orientable in inclination about its longitudinal axis.

46. The device according to claim 37, wherein the transparent outer container of the isolation cell, that completely isolates the contents thereof from ambient air when said outer container is screwed to the knob for adjusting the pressure inside the closed cell; the adjustment knob with an abutment being mounted via a pivot connection on the main body with pivoting limited to 90° relative to the longitudinal axis of the cell.

47. The device according to claim 46, wherein the knob has two adjustment positions making it possible to pass progressively from a position of minimum opening with the outside to a maximally open position making it possible to go progressively from negative internal pressure to positive internal pressure obtained by equilibrium between the incoming anesthetic flow rate and the residual extraction flow rate that exists within the device fitted with its transparent outer container.
